(19) United States
(12) Patent Application Publication
(10) Pub. No.: US 2025/0253447 A1
(43) Pub. Date: Aug. 7, 2025

(54) BATTERY COOLING SYSTEM AND METHOD

(71) Applicant: GM GLOBAL TECHNOLOGY OPERATIONS LLC, DETROIT, MI (US)

(72) Inventors: Chao Wan, Shanghai (CN); Wenshui Wang, Shanghai (CN); Xiaolin Zhu, Shanghai (CN)

(21) Appl. No.: 18/666,030

(22) Filed: May 16, 2024

(30) Foreign Application Priority Data
Feb. 2, 2024 (CN) 202410152909.2

(51) Int. Cl. H01M 10/663; H01M 10/613; H01M 10/625; H01M 10/6554; H01M 10/6563

(52) U.S. Cl. CPC H01M 10/663; H01M 10/613; H01M 10/625; H01M 10/6554; H01M 10/6563

(57) ABSTRACT

A battery assembly of a vehicle includes a battery having a plurality of battery cells, and a plurality of refrigerant spray nozzles operably connected to a heating, ventilation and air conditioning (HVAC) system of the vehicle. The plurality of refrigerant spray nozzles are configured to spray a flow of refrigerant from the HVAC system onto the plurality of battery cells in the event of detection of thermal runaway event. A method of cooling a battery assembly of a vehicle includes detecting a thermal event at the battery assembly, diverting a flow of refrigerant from a heating ventilation and air conditioning (HVAC) system in response to the detection of the thermal event, and spraying the flow of refrigerant from a plurality of refrigerant spray nozzles onto a plurality of battery cells of the battery assembly to cool the battery assembly.

### CROSS REFERENCE TO RELATED APPLICATIONS

This application claims the benefit of Chinese Application No. 202410152909.2 filed Feb. 2, 2024, the disclosure of which is incorporated herein by reference in its entirety.

### INTRODUCTION

The subject disclosure relates to vehicles, and in particular to rechargeable energy storage systems (RESSs) or battery systems, for vehicles.

RESSs are utilized to provide electrical energy to drive propulsion systems such as electric motors and/or other vehicle systems. The typical RESS contains a plurality of cell modules each containing a plurality of battery cells. During operation, it is necessary to provide cooling to the RESS to maintain a desired operating temperature and performance of the RESS. Often the cooling is provided by a flow of coolant directed to the RESS via a cold plate or the like. This flow of coolant is tied to a heating, ventilation and air conditioning (HVAC) system of the vehicle.

The HVAC system includes a flow of refrigerant therethrough. As the industry moves toward refrigerants having relatively low global warming potential (GWP), it is desired to include such refrigerants, one example of which is CO₂, into HVAC systems. Further, it is desired to utilize such low GWP refrigerants to cool the RESS, especially when the RESS experiences a high temperature condition, which may correspond to an approach to a thermal runaway condition.

### SUMMARY

In one exemplary embodiment, a battery assembly of a vehicle includes a battery having a plurality of battery cells, and a plurality of refrigerant spray nozzles operably connected to a heating, ventilation and air conditioning (HVAC) system of the vehicle. The plurality of refrigerant spray nozzles are configured to spray a flow of refrigerant from the HVAC system onto the plurality of battery cells in the event of detection of thermal runaway event.

In addition to one or more of the features described herein a cold plate is positioned at the plurality of battery cells to cool the plurality of battery cells.

In addition to one or more of the features described herein a flow of coolant is directed through the cold plate.

In addition to one or more of the features described herein the plurality of refrigerant spray nozzles are arrayed on a refrigerant spray manifold.

In addition to one or more of the features described herein a quick connect arrangement to is configured to connect the refrigerant spray manifold to the HVAC system.

In addition to one or more of the features described herein a pressure reduction valve is configured to reduce the pressure of the flow of refrigerant prior to spraying the flow of refrigerant from the refrigerant spray nozzles.

In addition to one or more of the features described herein the flow of refrigerant is CO₂.

In another exemplary embodiment, a vehicle includes a vehicle body defining a passenger compartment, a propulsion system to drive a movement of the vehicle, and a heating ventilation and air conditioning (HVAC) system configured to provide cooling and or heating to the passenger compartment. The HVAC system has a flow of refrigerant circulating therethrough. A battery assembly is operably connected to the propulsion system to power the propulsion system. The battery assembly includes a battery including a plurality of battery cells, and a plurality of refrigerant spray nozzles operably connected to the HVAC system. The plurality of refrigerant spray nozzles are configured to spray the flow of refrigerant from the HVAC system onto the plurality of battery cells in the event of detection of thermal runaway event.

In addition to one or more of the features described herein a cold plate is positioned at the plurality of battery cells to cool the plurality of battery cells.

In addition to one or more of the features described herein a flow of coolant is directed through the cold plate.

In addition to one or more of the features described herein the plurality of refrigerant spray nozzles are arrayed on a refrigerant spray manifold.

In addition to one or more of the features described herein a quick connect arrangement is configured to connect the refrigerant spray manifold to the HVAC system.

In addition to one or more of the features described herein a pressure reduction valve is configured to reduce the pressure of the flow of refrigerant prior to spraying the flow of refrigerant from the refrigerant spray nozzles.

In addition to one or more of the features described herein the flow of refrigerant is CO₂.

In another exemplary embodiment, a method of cooling a battery assembly of a vehicle includes detecting a thermal event at the battery assembly, diverting a flow of refrigerant from a heating ventilation and air conditioning (HVAC) in response to the detection of the thermal event, and spraying the flow of refrigerant from a plurality of refrigerant spray nozzles onto a plurality of battery cells of the battery assembly to cool the battery assembly.

In addition to one or more of the features described herein a pressure of the flow of refrigerant is reduced via a pressure reduction valve.

In addition to one or more of the features described herein the plurality of refrigerant spray nozzles are arrayed on a refrigerant spray manifold.

In addition to one or more of the features described herein a quick connect arrangement is configured to connect the refrigerant spray manifold to the HVAC system.

In addition to one or more of the features described herein the flow of refrigerant is CO₂.

In addition to one or more of the features described herein a flow of coolant is circulated from a battery chiller in thermal communication with the HVAC system through the battery assembly.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an exemplary embodiment of a vehicle;

FIG. 2 is a schematic illustration of an exemplary embodiment of a heating ventilation and air conditioning (HVAC) system of a vehicle;

FIG. 3 is a schematic illustration of an exemplary embodiment of a spray cooling arrangement of a vehicle battery assembly; and

FIG. 4 is a schematic illustration of an exemplary method of operating a spray cooling arrangement.

### DETAILED DESCRIPTION

The following description is merely exemplary in nature and is not intended to limit the present disclosure, its application or uses. It should be understood that throughout the drawings, corresponding reference numerals indicate like or corresponding parts and features.

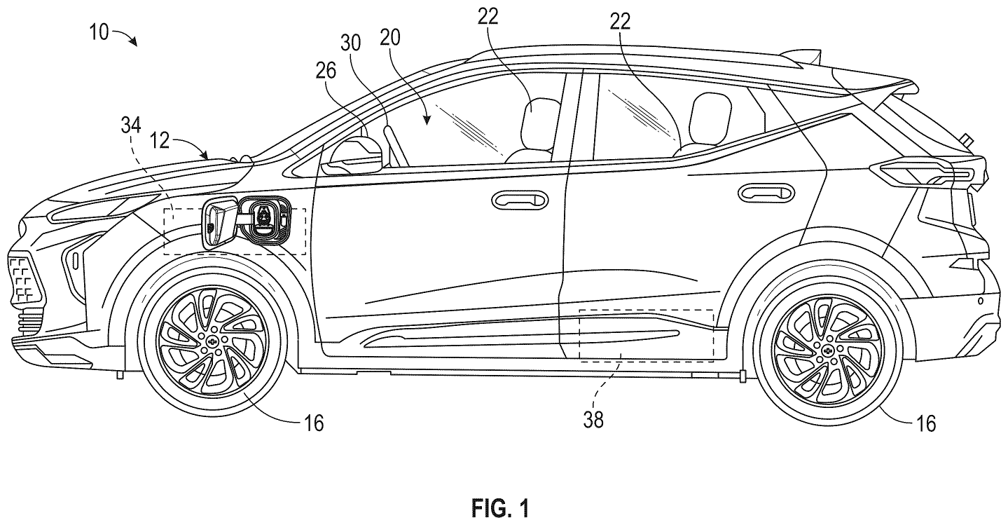

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) or battery assembly 38 provides power to electric motor 34.

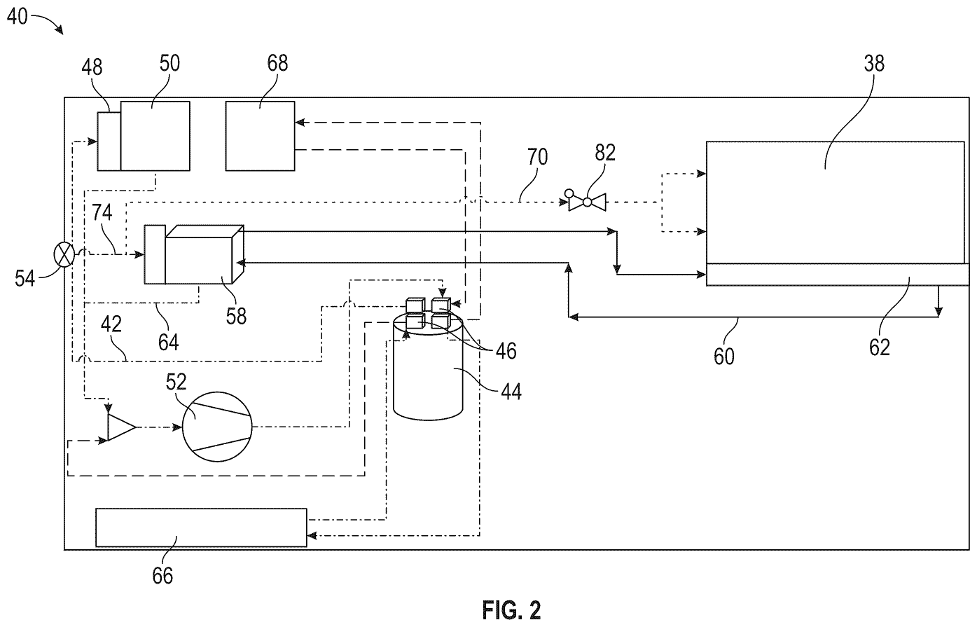

Referring now to FIG. 2, illustrated is an embodiment of a heating, ventilation and air conditioning (HVAC) system 40 of the vehicle 10. The HVAC system 40 is configured to provide cooling and/or heating to the passenger compartment 20 and generally has a heat pump configuration. A flow of refrigerant, such as a CO₂ refrigerant, is circulated through the HVAC system 40 along one or more refrigerant pathways 42. The HVAC system 40 includes a refrigerant reservoir 44 at which a plurality of reservoir valves 46 are positioned and configured to direct the flow of refrigerant to and from the refrigerant reservoir 44, which in some embodiments has a capacity in the range of 300 g to 600 g of CO₂.

When the HVAC system 40 is operated in cooling mode, such as illustrated in FIG. 2, the flow of refrigerant exits the refrigerant reservoir 44 and is directed through a cabin expansion valve 48, and into a cabin evaporator 50, where thermal energy exchange with airflow in the passenger compartment 20 cools the passenger compartment 20. The flow of refrigerant is returned to the refrigerant reservoir 44 via a compressor 52, which compresses the flow of refrigerant before it reenters the refrigerant reservoir 44.

Additionally, upstream of the cabin evaporator 50, the flow of refrigerant is directed through a battery chiller valve 54 that selectably directs a portion of the flow of refrigerant through a chiller expansion valve 56 and to a battery chiller 58. The battery chiller 58 is operably connected to the battery assembly 38, such that a flow of coolant is circulated from the battery assembly 38 via one or more coolant pathways 60 and through the battery chiller 58. At the battery chiller 58, thermal energy is exchanged between the flow of refrigerant and the flow of coolant to reduce a coolant temperature. The flow of coolant is then returned to the battery assembly 38 to cool the battery assembly 38 by flowing through, for example, a cold plate 62 in thermal contact with the battery assembly 38, such as positioned below the battery assembly 38. The flow of refrigerant is directed from the battery chiller 58 via a chiller return pathway 64 to rejoin the one or more refrigerant pathways 42.

Additionally, the HVAC system 40 includes a recovery heat exchanger 66 operably connected to the refrigerant reservoir 44 via the one or more reservoir valves 46. At least a portion of the flow of refrigerant is selectably directed through the recovery heat exchanger 66 to reject thermal energy from the flow of refrigerant when operated in a cooling mode or to absorb thermal energy from ambient when operated in a heating mode. In some embodiments, for operating in a heating mode, the HVAC system 40 includes a cabin condenser 68 through which the flow of refrigerant is directed from the refrigerant reservoir 44 to provide heating to the passenger compartment 20.

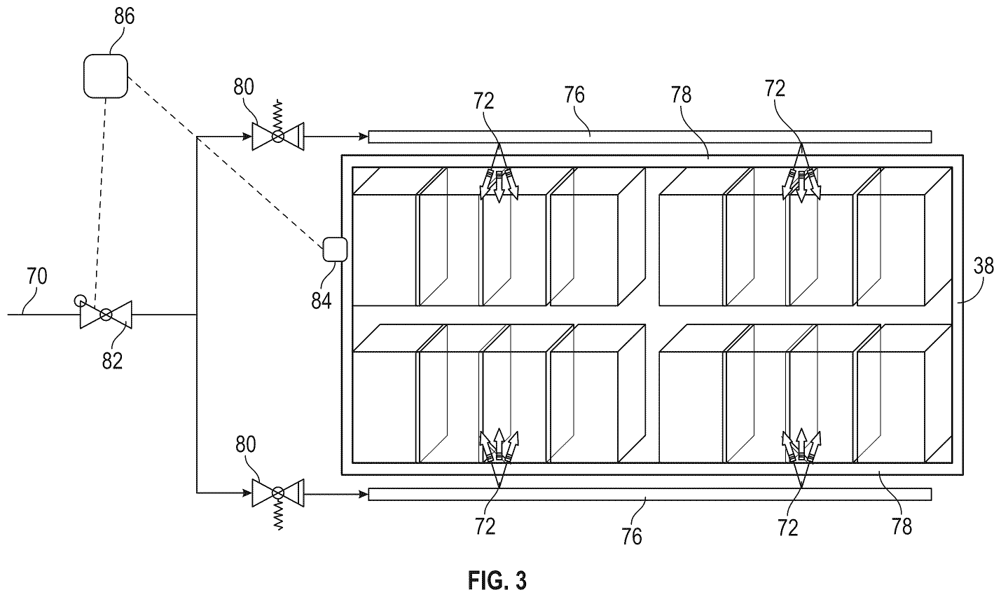

Referring now to FIG. 2 and FIG. 3, the HVAC system 40 further includes a refrigerant spray arrangement including one or more refrigerant spray lines 70 terminating at the battery assembly 38 in one or more spray nozzles 72. In some embodiments, the refrigerant spray lines 70 are connected to the one or more refrigerant pathways 42 downstream of the reservoir 44 along, for example, a battery chiller branch 74 of the one or more refrigerant pathways 42.

As shown best in FIG. 3, the spray nozzles 72 are arrayed along spray manifolds 76 extending along, for example, opposing lateral sides 78 of the battery assembly 38. In some embodiments, the spray manifolds 76 and spray nozzles 72 are part of a modular assembly together with the battery assembly 38, and the spray manifolds 76 are connected to the refrigerant spray lines 70 via quick connectors 80. A pressure reduction valve 82 is located along the refrigerant spray lines 70 to, when opened, allow a flow of refrigerant along the refrigerant spray lines 70, through the spray manifolds 76 and out of the spray nozzles 72. Further, the pressure reduction valve 82 is configured to reduce a refrigerant pressure flowing therethrough from a relatively high pressure, in some embodiments in the range of 15-20 bar or more, to a relatively low pressure to be output by the spray nozzles 72.

The flow of refrigerant is output from the spray nozzles 72 toward the battery assembly 38 to quickly cool the battery assembly 38 in the event of detection of a condition in the battery assembly 38, such as a relatively high level of H₂ or a relatively high temperature, that is indicative of the battery assembly 38 approaching a thermal runaway condition.

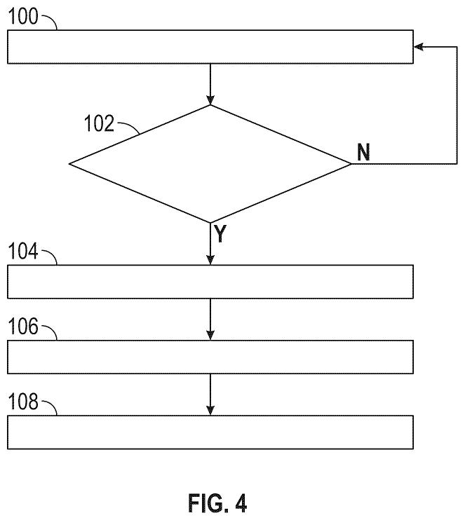

With reference to FIG. 4 and continued reference to FIG. 3, a sensor such as an H₂ sensor 84, or alternatively a temperature sensor, is located at the battery assembly 38. The H₂ sensor 84 monitors the level of H₂ at the battery assembly at step 100 and compares the detected H₂ level to a predetermined threshold at step 102 via a controller 86. If the detected H₂ level exceeds the threshold, the controller 86 signals the pressure reduction valve 82 to move from a closed position to an opened position at step 104. Opening of the pressure reduction valve allows for the flow of refrigerant to flow through the spray manifolds 76 and out of the spray nozzles 72 at step 106. The temperature of the battery assembly 38 is lowered by the flow of refrigerant from the spray nozzles 72 at step 108.

Utilizing the refrigerant spray arrangement to cool the battery assembly 38 in the event of a thermal runaway provides increased time for securing of the vehicle and exploits the existing heat pump system having CO₂ refrigerant, as an alternative to utilizing a separate fire extinguishing system thus simplifying construction of the vehicle.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly of a vehicle comprising:
a battery comprising a plurality of battery cells; and
a plurality of refrigerant spray nozzles operably connected to a heating, ventilation and air conditioning (HVAC) system of the vehicle, the plurality of refrigerant spray nozzles configured to spray a flow of refrigerant from the HVAC system onto the plurality of battery cells in an event of detection of a thermal runaway event.

2. The battery assembly of claim 1, further comprising a cold plate disposed at the plurality of battery cells to cool the plurality of battery cells.

3. The battery assembly of claim 2, wherein a flow of coolant is directed through the cold plate.

4. The battery assembly of claim 1, wherein the plurality of refrigerant spray nozzles are arrayed on a refrigerant spray manifold.

5. The battery assembly of claim 4, further comprising a quick connect arrangement to connect the refrigerant spray manifold to the HVAC system.

6. The battery assembly of claim 1, further comprising a pressure reduction valve to reduce pressure of the flow of refrigerant prior to spraying the flow of refrigerant from the refrigerant spray nozzles.

7. The battery assembly of claim 1, wherein the flow of refrigerant is CO₂.

8. A vehicle comprising:
a vehicle body defining a passenger compartment;
a propulsion system to drive a movement of the vehicle;
a heating ventilation and air conditioning (HVAC) system configured to provide cooling and or heating to the passenger compartment, the HVAC system having a flow of refrigerant circulating therethrough; and
a battery assembly operably connected to the propulsion system to power the propulsion system, the battery assembly including:
a battery including a plurality of battery cells; and
a plurality of refrigerant spray nozzles operably connected to the HVAC system, the plurality of refrigerant spray nozzles configured to spray the flow of refrigerant from the HVAC system onto the plurality of battery cells in an event of detection of thermal runaway event.

9. The vehicle of claim 8, further comprising a cold plate disposed at the plurality of battery cells to cool the plurality of battery cells.

10. The vehicle of claim 9, wherein a flow of coolant is directed through the cold plate.

11. The vehicle of claim 8, wherein the plurality of refrigerant spray nozzles are arrayed on a refrigerant spray manifold.

12. The vehicle of claim 11, further comprising a quick connect arrangement to connect the refrigerant spray manifold to the HVAC system.

13. The vehicle of claim 8, further comprising a pressure reduction valve to reduce pressure of the flow of refrigerant prior to spraying the flow of refrigerant from the refrigerant spray nozzles.

14. The vehicle of claim 8, wherein the flow of refrigerant is CO₂.

15. A method of cooling a battery assembly of a vehicle, comprising:
detecting a thermal event at the battery assembly;
diverting a flow of refrigerant from a heating ventilation and air conditioning (HVAC) system in response to the detection of the thermal event; and
spraying the flow of refrigerant from a plurality of refrigerant spray nozzles onto a plurality of battery cells of the battery assembly to cool the battery assembly.

16. The method of claim 15, further comprising reducing a pressure of the flow of refrigerant via a pressure reduction valve.

17. The method of claim 15, wherein the plurality of refrigerant spray nozzles are arrayed on a refrigerant spray manifold.

18. The method of claim 17, further comprising a quick connect arrangement to connect the refrigerant spray manifold to the HVAC system.

19. The method of claim 15, wherein the flow of refrigerant is CO₂.

20. The method of claim 15, further comprising circulating a flow of coolant from a battery chiller in thermal communication with the HVAC system through the battery assembly.
